(19) United States
(12) Patent Application Publication
(10) Pub. No.: US 2019/0243356 A1
(43) Pub. Date: Aug. 8, 2019

(54) METHOD FOR CONTROLLING FLIGHT OF AN AIRCRAFT, DEVICE, AND AIRCRAFT

(71) Applicant: SZ DJI TECHNOLOGY CO., LTD., Shenzhen (CN)

(72) Inventors: Xiao HU, Shenzhen (CN); Ang LIU, Shenzhen (CN); Litian ZHANG, Shenzhen (CN)

(21) Appl. No.: 16/384,300

(22) Filed: Apr. 15, 2019

Related U.S. Application Data
(63) Continuation of application No. PCT/CN2016/102288, filed on Oct. 17, 2016.

(51) Int. Cl. G05D 1/00; B64C 39/02; G05D 1/08; B64D 47/08

(52) U.S. Cl. CPC G05D 1/0038; B64C 39/024; B64C 2201/146; G05D 1/0808; B64D 47/08; G05D 1/0094

(57) ABSTRACT

A method for controlling flight of an aircraft includes obtaining a location of a target area in an image captured by an imaging device mounted on the aircraft. The method also includes determining, based on the location of the target area, a relative direction of a target object corresponding to the target area relative to the aircraft. The method also includes determining a first direction of the aircraft based on the relative direction, the first direction being a direction approaching the target object. The method also includes based on a determination that the aircraft is in a moving-away flight mode, determining a second direction based on the first direction, the second direction being opposite the first direction. The method further includes controlling the flight of the aircraft based on the second direction.

### CROSS-REFERENCE TO RELATED APPLICATION

This application is a continuation application of International Application No. PCT/CN2016/102288, filed on Oct. 17, 2016, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technology field of aircrafts and, more particularly, to a method for controlling the flight of an aircraft, a device, and an aircraft.

### BACKGROUND

An unmanned aerial vehicle (“UAV”) is often equipped with an imaging device, such as a camera, a camcorder, to capture images of a particular area. The imaging device carried by the UAV can satisfy user demands for scenic photography, aerial surveillance, etc.

In current technologies, when photographing an environmental object, a user needs to manually control the aircraft to capture images of certain target areas or objects. Alternatively, the user needs to plan a flight path (or route) such that the aircraft can fly autonomously along the planned flight path to capture images of an environment. These methods require the user to control the flight of the aircraft or carry out complex flight path planning during the entire process. As a result, the control methods used in the current technologies tend to be complex.

### SUMMARY

In accordance with the present disclosure, there is provided a method for controlling flight of an aircraft. The method includes obtaining a location of a target area in an image captured by an imaging device mounted on the aircraft. The method also includes determining, based on the location of the target area, a relative direction of a target object corresponding to the target area relative to the aircraft. The method also includes determining a first direction based on the relative direction, the first direction being a direction approaching the target object. The method also includes based on a determination that the aircraft is in a moving-away flight mode, determining a second direction based on the first direction, the second direction being opposite the first direction. The method further includes controlling the flight of the aircraft based on the second direction.

In accordance with the present disclosure, there is also provided a flight control device for controlling flight of an aircraft. The flight control device includes a memory configured to store computer-executable instructions. The flight control device also includes an acquisition processor configured to execute the computer-executable instructions to obtain a location of a target area in an image captured by an imaging device mounted on the aircraft. The flight control device also includes a determination processor configured to execute the computer-executable instructions to determine, based on the location of the target area, a relative direction of a target object corresponding to the target area relative to the aircraft. The determination processor is also configured to determine a first direction based on the relative direction, the first direction being a direction approaching the target object. The flight control device further includes a control processor configured to execute the computer-executable instructions to determine that the aircraft is in a moving-away flight mode, and based on the determination that the aircraft is in the moving-away flight mode, determine a second direction based on the first direction, the second direction being opposite the first direction. The control processor is also configured to control the flight of the aircraft based on the second direction.

In accordance with the present disclosure, there is further provided an aircraft. The aircraft includes a propulsion assembly configured to provide a propulsion force for flight of the aircraft. The aircraft also includes a flight control device configured to obtain a location of a target area in an image captured by an imaging device mounted on the aircraft. The flight control device is also configured to determine, based on the location of the target area, a relative direction of a target object corresponding to the target area relative to the aircraft. The flight control device is also configured to determine a first direction based on the relative direction, the first direction being a direction approaching the target object. The flight control device is also configured to, based on a determination that the aircraft is in a moving-away flight mode, determine a second direction based on the first direction, the second direction being opposite the first direction. The flight control device is further configured to transmit a flight control instruction to the propulsion assembly based on the second direction. The flight control instruction is configured for controlling flight of the aircraft.

The present disclosure provides a method for controlling the flight of an aircraft. A flight direction of the aircraft is determined based on a location of a target area in an image captured by an imaging device carried by the aircraft. A user can select a target object for capturing images thereof in the target area. The operation is simple, which improves the efficiency of controlling the flight of the aircraft for the purpose of capturing images of the target object. User demands for automation and intelligence of the flight control of aircrafts and image capturing can be satisfied.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a schematic illustration of a flight control system according to an example embodiment.

FIG. 2 is a schematic illustration of a user interface according to an example embodiment.

FIG. 3 is a schematic illustration of an aircraft carrying an imaging device according to an example embodiment.

FIG. 4 is a flow chart illustrating a method for controlling flight of an aircraft according to an example embodiment.

FIG. 5 is a flow chart illustrating a method for controlling flight of an aircraft according to another example embodiment.

FIG. 6 is a schematic diagram of a flight control device according to an example embodiment.

FIG. 7 is a schematic illustration of the structure of an aircraft according to an example embodiment.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

Example embodiments will be described with reference to the accompanying drawings, in which the same numbers refer to the same or similar elements unless otherwise specified.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “vertical,” “left,” “right,” “up,” “upward,” “upwardly,” “down,” “downward,” “downwardly,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed. The term “communicatively coupled” indicates that related items are coupled or connected through a communication chancel, such as a wired or wireless communication channel.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

The following descriptions explain example embodiments of the present disclosure, with reference to the accompanying drawings. Unless otherwise noted as having an obvious conflict, the embodiments or features included in various embodiments may be combined.

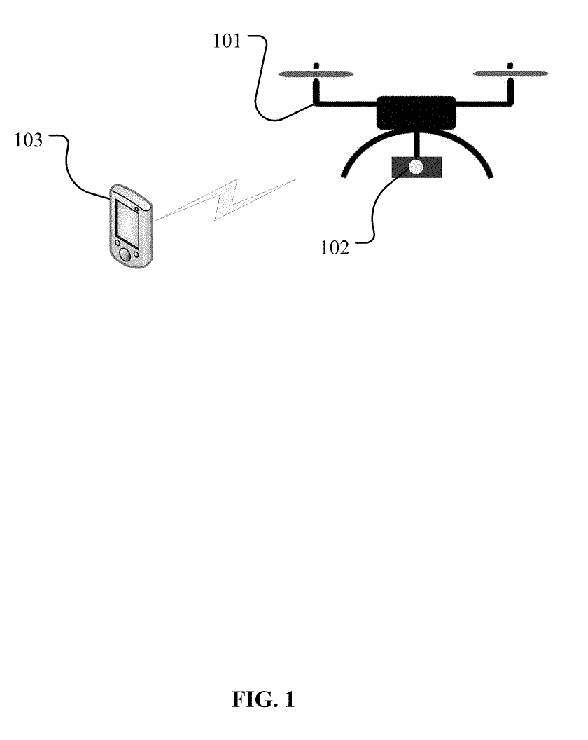

As shown in FIG. 1, an aircraft 101 may carry an imaging device 102 configured for capturing images of an environment in which the aircraft 101 is operated. The aircraft 101 may transmit, in real time, data of the captured images to a ground terminal while capturing the images. FIG. 1 schematically illustrates a flight control system that may include the aircraft 101, the imaging device 102 carried by the aircraft 101, and the ground terminal.

In some embodiments, the imaging device 102 may transmit the data of the captured images to the aircraft 101 through a wired or wireless communication. The aircraft 101 may transmit the data of the captured images to the ground terminal. In some embodiments, the imaging device 102 may directly transmit the data of the captured images to the ground terminal. In some embodiments, the ground terminal may be a dedicated remote control device for the aircraft. In some embodiments, the ground terminal may be any suitable smart terminal, such as a smart phone, a tablet, or a personal computer, which may communicatively couple with the aircraft 101 or the imaging device 102 through a wireless communication. In FIG. 1, a smart terminal 103 is used as an example of the ground terminal. The ground terminal may receive data from the aircraft 101 or the imaging device 102, and display the received data. In some embodiments, the ground terminal may transmit instructions to the aircraft 101 or the imaging device 102 to control the flight of the aircraft 101 or to control the imaging operations of the imaging device 102.

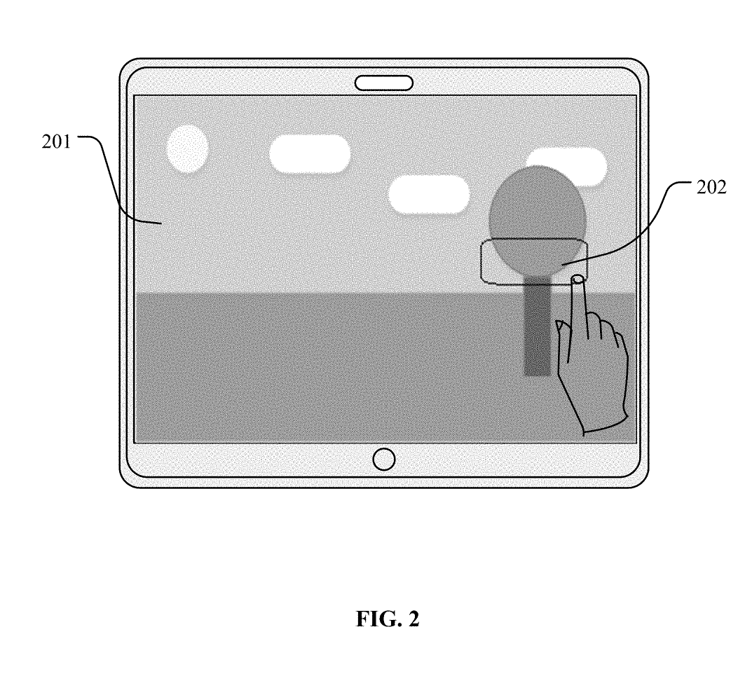

In some embodiments, while the aircraft 101 flies in an environment, the imaging device 102 may capture images of a portion of the environment that appears in a field of view of the imaging device 102. The imaging device 102 may transmit data of the captured images to the smart terminal 103. The smart terminal 103 may display the images to a user on a screen of the smart terminal 103. In some embodiments, a user may select a target area in an image through various methods, such as through touching the screen (e.g., a touch screen), or clicking or selecting an area on the screen using a mouse, etc. The target area may be a point or a region selected by the user. As shown in FIG. 2, in a user interface for selecting a target area, an image 201 captured by the imaging device 102 is displayed. The user may touch the touch screen to select a target area 202.

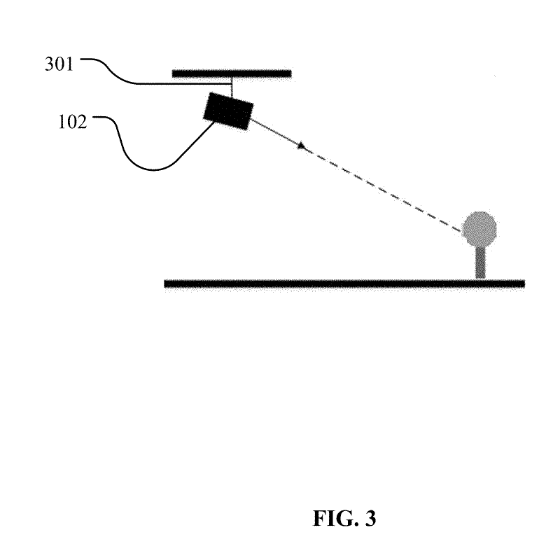

In some embodiments, the smart terminal 103 may determine a location of the target area in the image based on a user's selection. The smart terminal 103 may further determine a relative direction of a target object corresponding to the target area relative to the aircraft 101. For example, the smart terminal 103 may determine the relative direction of the target object corresponding to the target area based on a location of the target area in the image. In some embodiments, if the target area is located at a lower portion of the image, the smart terminal 103 may determine that a physical location of the target object corresponding to the target area in the environment is below the aircraft 101. Based on the relative direction, the smart terminal 103 may adjust the aircraft 101 and/or a gimbal carried by the aircraft 101, thereby adjusting an angle of imaging for the imaging device 102. Adjusting the angle of imaging of the imaging device 102 may result in the imaging device 102 pointing to the target object, or result in the target object being located at or near a center region of the image or the field of view of the imaging device 102. For example, when the target area is located right below the aircraft 101, the smart terminal 103 may control the aircraft 101 to reduce the flight height, such that the target area is located at or near a center region of the image or the field of view of the imaging device 102. As a result, the imaging device 102 may point to the target object to capture images, or the target object may be located at or near a center region of the image or the field of view of the imaging device 102. In some embodiments, when the target area is right below the aircraft 101, the smart terminal 103 may control the gimbal to adjust the pitch angle of the gimbal, such that the target area is located at or near a center region of the image or the field of view of the imaging device 102. In some embodiments, as a result of controlling the gimbal to adjust the pitch angle of the gimbal, the imaging device 102 may be adjusted to point to the target object while capturing images of the target object. In some embodiments, as a result of controlling the gimbal to adjust the pitch angle of the gimbal, the target object may be located at or near a center region of the image or the field of view of the imaging device 102. As shown in FIG. 3, the smart terminal 103 may adjust the pitch angle of a gimbal 301, such that the imaging device 102 may capture an image of the target object.

In some embodiments, after determining the relative direction of the target object, the smart terminal 103 may further determine a flight direction of the aircraft 101. In some embodiments, the aircraft 101 may be operated in one of at least two flight modes, a first flight mode (e.g., moving-away flight mode) and a second flight mode (e.g., moving-closer flight mode). The flight directions may be different in different flight modes. In some embodiments, the smart terminal 103 may determine a first direction based on the relative direction of the target object relative to the aircraft 101. The first direction may be a direction approaching the target object. For example, if the relative direction indicates that the target object is located in a right lower direction of the aircraft 101, the first direction may be determined as the right lower direction from the aircraft 101 toward the target object.

In some embodiments, after determining the first direction, the smart terminal 103 may determine that the aircraft 101 is in a first flight mode (e.g., moving-away flight mode). Based on the determination that the aircraft 101 is in the first flight mode, the smart terminal 103 may determine a second direction based on the first direction. The second direction may be a flight direction of the aircraft 101. In some embodiments, the second direction may be opposite the first direction. In some embodiments, when the aircraft 101 is in the first flight mode, the aircraft 101 may fly away from the target object. The imaging device 102 may capture images of the target object in the moving-away flight mode while the aircraft 101 flies away from the target object.

In some embodiments, after determining the first direction, the smart terminal 103 may determine that the aircraft 101 is in a second flight mode (e.g., moving-closer flight mode). Based on the determination that the aircraft 101 is in the second flight mode, the aircraft 101 may fly approaching (e.g., flying closer to) the target object. The imaging device 102 may capture images of the target object in the moving-closer flight mode while the aircraft 101 flies closer to the target object.

In some embodiments, the user may set the flight mode of the aircraft 101 on a mobile application, such that the aircraft 101 may be placed in the first flight mode or the second flight mode. Alternatively, the user may set an imaging mode for the imaging device 102. When the imaging mode is set to be the moving-away flight mode, the smart terminal 103 may determine that the flight mode of the aircraft 101 is the first flight mode. When the imaging mode is set to be the moving-closer flight mode, the smart terminal 103 may determine that the flight mode of the aircraft 103 is the second flight mode.

In some embodiments, the aircraft 101 may include other flight modes, such as a third flight mode (e.g., headless flight mode). In the third flight mode, the aircraft 101 may carry out a headless flight. In other words, in the third flight mode, the yaw angle of the aircraft 101 may be freely controlled by the user. When the aircraft 101 activates the third flight mode, the flight direction of the aircraft 101 can be either in the first direction (a direction approaching the target object) or the second direction (a direction moving away from the target object). In some embodiments, when the aircraft 101 activates the third flight mode, the aircraft 101 may fly along a predetermined flight path. The user may control a remote control device to cause the aircraft 101 to rotate freely around a yaw axis. Any side of the aircraft 101 may be facing a flight direction or a direction opposite the flight direction. In some embodiments, based on a detection of an instruction provided by the user for switching the flight mode to the third flight mode, the smart terminal 103 may control the aircraft 101 to enter or activate the third flight mode. In the third flight mode, the user may freely adjust the yaw angle of the aircraft 101. For example, while the aircraft 101 flies in the first direction or the second direction, based on receipt of a control instruction including a yaw angle, the smart terminal 103 may control the aircraft 101 to enter or activate the third flight mode. In the third flight mode, the aircraft 101 may release a control of a yaw direction of the aircraft 101 to the user. While maintaining the aircraft 101 to fly in the first direction or the second direction, the user can control the aircraft 101 to freely rotate around the yaw axis.

While the aircraft 101 flies in the first direction or the second direction, in the user interface (e.g., the one shown in FIG. 2) for selecting the target area, the user can re-select the target area at any time. In some embodiments, the smart terminal 103 may detect, in real time, the user's selection in the user interface. The smart terminal 103 may determine an area selected by the user as the target area, and re-calculate the location of the newly selected target area in the image. The smart terminal 103 may transmit the location of the newly selected target area in the image to the aircraft 101. The aircraft 101 may determine a new flight direction based on the location of the newly selected target area based on the above-described processes.

In some embodiments, while the aircraft 101 automatically flies in the first flight mode (e.g., moving-away flight mode), the second flight mode (e.g., moving-closer flight mode), or the third flight mode (e.g., headless flight mode), the aircraft 101 may exit the flight mode. For example, when the aircraft 101 flies in the current flight mode, based on a detection of the aircraft satisfying a predetermined exit condition, the smart terminal 103 may control the aircraft 101 to exit the current flight mode. In some embodiments, the detection of the aircraft satisfying the predetermine exit condition may include receipt of a control instruction instructing the aircraft to exit the current flight mode. In some embodiments, the detection of the aircraft satisfying the predetermined exit condition may include detection of a current location of the aircraft satisfying a predetermined flight-restricting condition. For example, while the aircraft 101 automatically flies in the first direction or the second direction, if the aircraft 101 flies to a predetermined flight-restricting area, such as an airport, the current location of the aircraft 101 may satisfy the predetermined flight-restricting condition, and the aircraft 101 may exit the current flight mode. In some embodiments, the aircraft 101 may hover in the air and notify the user to switch to a manual control mode. In some embodiments, the detection of the aircraft satisfying the predetermined exit condition may include detection of the aircraft satisfying a predetermined obstacle avoidance condition. For example, while the aircraft 101 flies in the first direction or the second direction, if the aircraft 101 detects an obstacle that poses a potential collision, such as when a distance to the obstacle is smaller than a predetermined obstacle avoidance distance, the aircraft 101 may determine that the predetermined obstacle avoidance condition is satisfied, and the aircraft 101 may exit the current flight mode. In some embodiments, the aircraft 101 may hover in the air and notify the user to switch to a manual control mode. In some embodiments, the detection of the aircraft satisfying the predetermine exit condition may include detection of a flight distance travelled by the aircraft operating in the current flight mode being greater than or equal to one or more predetermined distance values. In some embodiments, in the first flight mode, the second flight mode, or the third flight mode, the user can set a predetermined distance value. The aircraft 101 may automatically fly, in the first direction or the second direction, for a distance equal to the predetermined distance value and stop flying. In the meantime, the aircraft may exit the current flight mode.

In some embodiments, during the flight after the aircraft 101 has determined the flight direction, such as during the automatic flight in the first direction or the second direction, the aircraft 101 may detect whether there is an obstacle ahead of the aircraft 101 in the flight path. The aircraft 101 may take obstacle avoidance measures and may arrive at the destination safely. In some embodiments, the aircraft 101 may include an obstacle detecting device. For example, the aircraft 101 may include one or more binocular sensors mounted on one or multiple sides of the aircraft 101. The binocular sensors may detect or sense obstacle information from one or multiple sides of the aircraft 101. The aircraft 101 may automatically avoid the obstacle based on the obstacle information detected or sensed by the one or more binocular sensors. In some embodiments, the aircraft 101 may include one or more obstacle detecting devices on only a first side of the aircraft 101, and no obstacle detecting device is provided on a second side opposite the first side. Because the gimbal for carrying the imaging device 102 can be rotated 360°, the gimbal may be controlled to face the scene that is being imaged by the imaging device 102. The aircraft 101 may be controlled to rotate, such that the first side of the aircraft 101 faces the flight direction. In this manner, the aircraft 101 may use the obstacle detecting device provided on the first side to detect an obstacle in the flight direction.

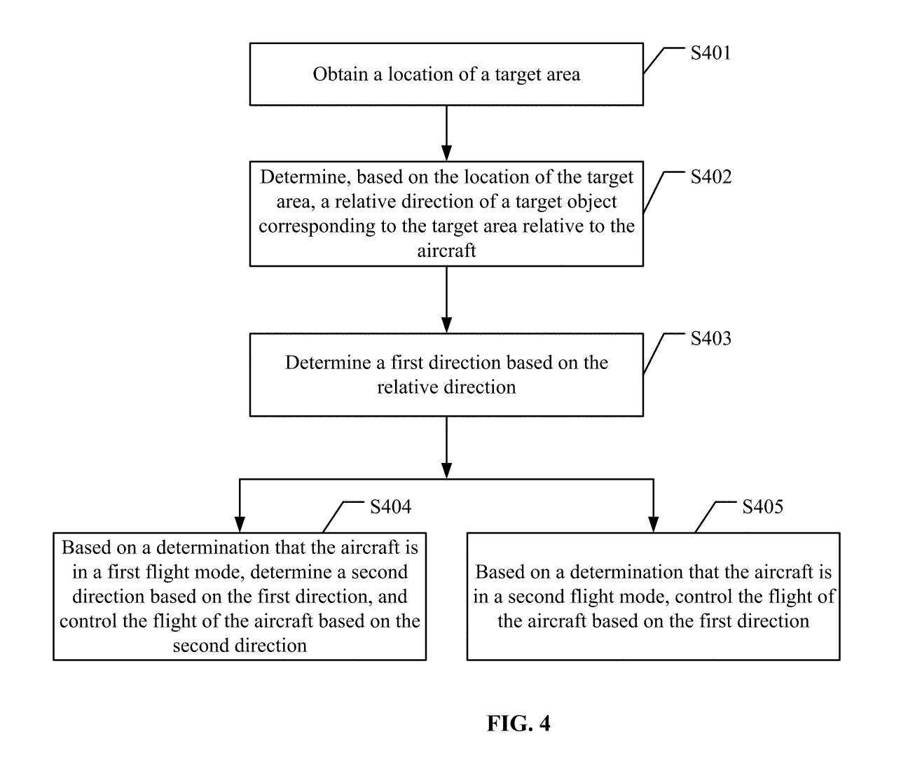

FIG. 4 is a flow chart illustrating a flight control method for controlling flight of an aircraft according to an example embodiment. The method may be executed by the aircraft, such as an unmanned aerial vehicle (“UAV”). The method includes the following steps:

In step S401, the aircraft may obtain a location of a target area in an image captured by an imaging device mounted on the aircraft. The target area may be an area selected by a user in the image, for example, by clicking operation on a touch screen on which the image is displayed, or by a sliding operation on the touch screen. In some embodiments, the pixel location of the target area selected by the user is determined to be the location of the target area.

In step S402, the aircraft may determine, based on the location of the target area, a relative direction of a target object corresponding to the target area relative to the aircraft. The relative direction refers to a direction of a target object corresponding to the target area relative to the aircraft in a viewing direction of the imaging device carried by the aircraft. The relative direction may be an approximate or rough direction. For example, the relative direction may be in the right lower direction relative to the aircraft, or in the left upper direction relative to the aircraft.

In step S403, the aircraft may determine a first direction based on the relative direction. The first direction may be a direction approaching the target object. Based on a determination of the relative direction, the first direction may be determined. For example, when determining that the target object is in a right lower direction relative to the aircraft, the first direction may be determined as a direction instructing the aircraft to fly in the right lower direction.

In step S404, based on a determination that the aircraft is in a first flight mode (e.g., moving-away flight mode), the aircraft may determine a second direction based on the first direction, and control the flight of the aircraft based on the second direction. The second direction may be opposite the first direction. In the first flight mode, the aircraft may fly in a direction moving away from the target object. After determining a flight direction, the method for controlling the aircraft to fly in the flight direction can implement any suitable existing technologies.

In step S405, based on a determination that the aircraft is in a second flight mode (e.g., moving-closer flight mode), the aircraft may control the flight based on the first direction. After determining a flight direction, the method for controlling the aircraft to fly in the flight direction can implement any suitable existing technologies.

The present disclosure provides a method for controlling the flight of an aircraft. A flight direction of the aircraft is determined based on a location of a target area in an image captured by an imaging device carried by the aircraft. A user can select a target object for capturing images thereof in the target area. The operation is simple, which improves the efficiency of controlling the flight of the aircraft for the purpose of capturing images of the target object. User demands for automation and intelligence of the flight control of aircrafts and image capturing can be satisfied.

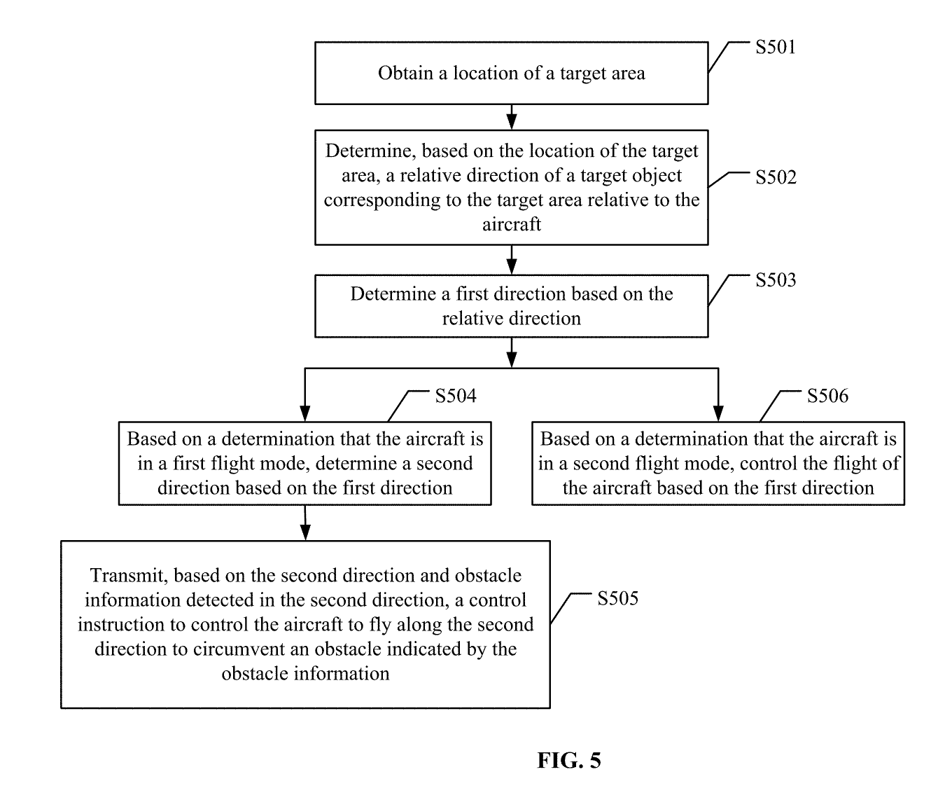

FIG. 5 is a flow chart illustrating a method for controlling flight of an aircraft according to another example embodiment. The method may be implemented by the aircraft, such as a UAV. The method includes the following steps:

Step S501, obtaining a location of a target area in an image captured by an imaging device mounted on the aircraft.

Step S502, determining, based on the location of the target area, a relative direction of a target object corresponding to the target area relative to the aircraft.

Step S503, determining a first direction based on the relative direction. The first direction may be a direction approaching the target object.

Step S504, based on a determination that the aircraft is in a first flight mode, determining a second direction based on the first direction. The second direction may be opposite the first direction.

Step S505, transmitting, based on the second direction and obstacle information detected in the second direction, a control instruction to control the aircraft to fly along the second direction to circumvent an obstacle indicated by the obstacle information.

In some embodiments, the aircraft may include one or more obstacle detecting devices. In step S505, detecting the obstacle information may include transmitting an attitude adjusting instruction to the aircraft for controlling an adjustment to an attitude of the aircraft, the adjustment to the attitude of the aircraft enabling the obstacle detecting device to detect the obstacle in the second direction and enabling the imaging device to capture an image of the target object during flight of the aircraft in the second direction. The obstacle detecting devices may be mounted on one or more sides of the aircraft. While the aircraft flies in the second direction, the obstacle detecting devices may not detect an obstacle in the second direction. For example, a side in the second direction of the aircraft may be a front side, and when the binocular distance sensor (an example of the obstacle detecting device) is located on a rear side of the aircraft, the binocular distance sensor may not detect the obstacle in the second direction. A solution to this is to adjust the attitude of the aircraft, such that one or more obstacle detecting devices can detect the obstacle in the second direction, thereby renders it possible to capture images of the target object while the aircraft flies in the second direction. For example, the aircraft may be rotated such that one or more obstacle detecting devices face the second direction. As a result, the obstacle detecting devices may detect the obstacle in the second direction. The lens of the imaging device may be rotated such that the field of view of the imaging device covers the target object.

In some embodiments, the aircraft includes one or more obstacle detecting devices. The imaging device can be rotatably mounted to the aircraft through a gimbal. In some embodiments, detecting the obstacle information in the second direction by the one or more obstacle detecting devices may include: transmitting an attitude adjusting instruction to the aircraft for controlling an adjustment to an attitude of the aircraft, the adjustment to the attitude of the aircraft enabling the obstacle detecting device to detect the obstacle in the second direction; transmitting a rotation instruction to the gimbal for controlling a rotation of the gimbal, the rotation of the gimbal enabling the imaging device to capture an image of the target object during flight of the aircraft in the second direction; enabling, by adjusting the attitude of the aircraft and the angle of the gimbal, the obstacle detecting devices to detect the obstacle in the second direction, thereby enabling the imaging device to capture images of the target object while the aircraft flies in the second direction. The gimbal may be a three-axis gimbal, which may rotate around a pitch axis, a roll axis, and a yaw axis. In some embodiments, the gimbal may be a rotating gimbal that can rotate 360°. The rotating gimbal may be quickly rotated to aim at the target object after the aircraft has rotated.

Step S506, based on a determination that the aircraft is in the second flight mode, controlling the flight of the aircraft based on the first direction. In the second flight mode, the aircraft may fly toward the target object.

The methods of FIGS. 4 and 5 may also be executed by a smart terminal or a dedicated remote control device. For example, the smart terminal or the remote control device may obtain the location of the target area selected by the user. The smart terminal or the remote control device may determine the flight direction (first direction or second direction) based on the location of the target area. The smart terminal or the remote control device may transmit a control instruction to the aircraft to instruct the aircraft to fly in the flight direction, such that the aircraft flies in the first direction or the second direction. The smart terminal or the remote control device may control the aircraft and/or the gimbal based on a location of the one or more obstacle detecting devices. As a result, the aircraft not only captures images of the environment corresponding to the target area, but also in the meantime autonomously avoids obstacles.

In some embodiments, while the aircraft flies in the first direction or the second direction, the smart terminal or the remote control device may determine whether the aircraft has activated or entered the third flight mode (e.g., headless flight mode). Based on a determination that the aircraft has activated or entered the third flight mode (e.g., is in the third mode), the smart terminal or the remote control device may instruct the aircraft to release the control of a yaw direction of the aircraft. The smart terminal or the remote control device may control, based on a received flight control instruction including a yaw angle, the aircraft to rotate in the yaw direction based on the yaw angle. In some embodiments, while the aircraft is in flight, when the smart terminal or the remote control device receives the flight control instruction including the yaw angle, the smart terminal or the remote control device may activate the third flight mode for the aircraft. In some embodiments, when the smart terminal or the remote control device detects receipt of the flight control instruction including the yaw angle, the smart terminal or the remote control device may treat the aircraft as having entered the third flight mode.

In some embodiments, while the aircraft automatically flies in the second direction in the first flight mode, or in the first direction in the second flight mode, or in the third flight mode, the smart terminal or the remote control may detect whether the aircraft satisfies a predetermined exit condition. If the aircraft satisfies the predetermined exit condition, the smart terminal or the remote control device may control the aircraft to exit the current flight mode. In some embodiments, the detection of the aircraft satisfying the predetermined exit condition may include at least one of: receipt of a control instruction for instructing the aircraft to exit the current flight mode, detection of a current location of the aircraft satisfying a predetermined flight-restricting condition, detection of the aircraft satisfying a predetermined obstacle avoidance condition, or detection of a flight distance travelled by the aircraft operating in the current flight mode being greater than or equal to one or more predetermined distance values.

In some embodiments, the present disclosure provides a non-transitory computer-readable medium. The computer-readable medium may be configured to store computer programs, such as computer-executable code or instructions. When the computer program is executed, for example, by a processor or controller, the processor or controller may perform the methods for controlling the flight of the aircraft, as shown in FIGS. 4 and 5.

In various embodiments of the present disclosure, the flight direction of the aircraft may be determined based on the location of the target area in the image. A user may select a target object for imaging from an image area. The operation is simple. The efficiency of flight control for capturing images of the target object is enhanced. User demands for automation and intelligence of the flight control of aircrafts and image capturing can be satisfied.

A flight control device for an aircraft and an example aircraft will be described below.

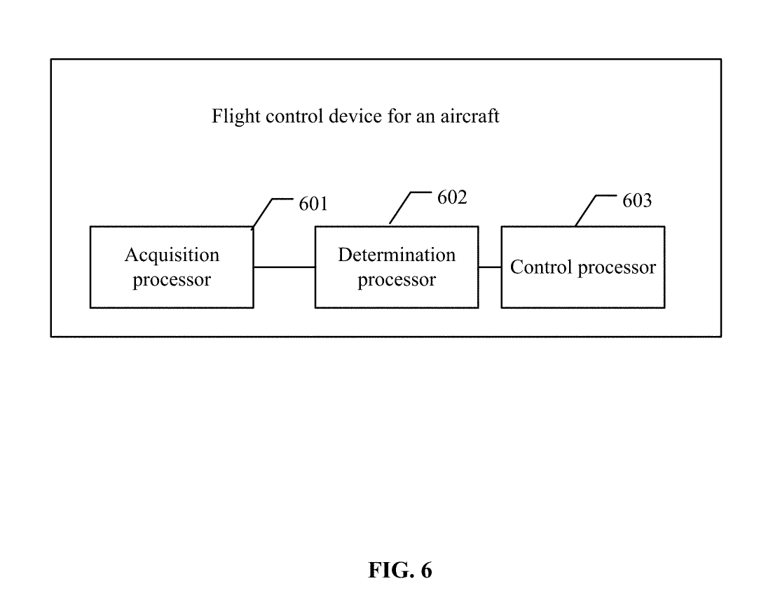

FIG. 6 schematically illustrates the structure of a flight control device for an aircraft. The flight control device may be included in the aircraft. For example, the flight control device may be part of a flight control apparatus or vice versa. In some embodiments, the flight control device may include the following components.

As shown in FIG. 6, the flight control device may include an acquisition processor 601 configured to execute computer-executable instructions stored in a memory to obtain a location of a target area in an image captured by an imaging device mounted on the aircraft. The flight control device may include a determination processor 602 configured to execute the computer-executable instructions to determine, based on the location of the target area, a relative direction of a target object corresponding to the target area relative to the aircraft. The determination processor 602 may also be configured to determine a first direction based on the relative direction, the first direction being a direction approaching the target object. The flight control device may include a control processor 603. In some embodiments, the control processor 603 may be configured to execute the computer-executable instructions to determine that the aircraft is in a first flight mode, and based on the determination that the aircraft is in the first flight mode, determine a second direction based on the first direction. The control processor 603 may also be configured to control the flight of the aircraft based on the second direction, the second direction being opposite the first direction.

In some embodiments, the control processor 603 may be configured to determine that the aircraft is in the second flight mode, and based on the determination that the aircraft is in the second flight mode, control the flight of the aircraft based on the first direction.

In some embodiments, during the flight of the aircraft, the control processor 603 may be configured to release a control of a yaw direction of the aircraft based on a determination that the aircraft is in a third flight mode. The control processor 603 may control, based on a received flight control instruction comprising a yaw angle, the aircraft to rotate in the yaw direction based on the yaw angle.

In some embodiments, during the flight of the aircraft in a current flight mode, the control processor 603 may be configured to control the aircraft to exit the current flight mode based on a detection that the aircraft satisfies a predetermined exit condition. The current flight mode may be the first flight mode, a second flight mode, or the third flight mode.

In some embodiments, the detection of the aircraft satisfying the predetermined exit condition may include at least one of: receipt of a control instruction for instructing the aircraft to exit the current flight mode, detection of a current location of the aircraft satisfying a predetermined flight-restricting condition, detection of the aircraft satisfying a predetermined obstacle avoidance condition, or detection of a flight distance travelled by the aircraft operating in the current flight mode being greater than or equal to one or more predetermined distance values.

In some embodiments, the control processor 603 is further configured to transmit, based on the second direction and obstacle information detected in the second direction, a control instruction to control the aircraft to fly along the second direction to circumvent an obstacle indicated by the obstacle information.

In some embodiments, the aircraft includes an obstacle detecting device configured to detect an obstacle. The control processor 603 may be configured to transmit an attitude adjusting instruction to the aircraft for controlling an adjustment to an attitude of the aircraft, the adjustment to the attitude of the aircraft enabling the obstacle detecting device to detect the obstacle in the second direction and enabling the imaging device to capture an image of the target object during flight of the aircraft in the second direction.

In some embodiments, the aircraft includes an obstacle detecting device configured to detect an obstacle. The imaging device is rotatably mounted to the aircraft through a gimbal. The control processor 603 may be configured to transmit an attitude adjusting instruction to the aircraft for controlling an adjustment to an attitude of the aircraft, the adjustment to the attitude of the aircraft enabling the obstacle detecting device to detect the obstacle in the second direction. The control processor 603 may also be configured to transmit a rotation instruction to the gimbal for controlling a rotation of the gimbal, the rotation of the gimbal enabling the imaging device to capture an image of the target object during flight of the aircraft in the second direction.

The implementation of the various components, devices, or processors of the present disclosure can refer to the descriptions of the corresponding methods and functions.

In various embodiments of the present disclosure, the flight direction of the aircraft may be determined based on the location of the target area in the image. A user may select a target object for imaging from an image area. The operation is simple. The efficiency of flight control for capturing images of the target object is enhanced. User demands for automation and intelligence of the flight control of aircrafts and image capturing can be satisfied.

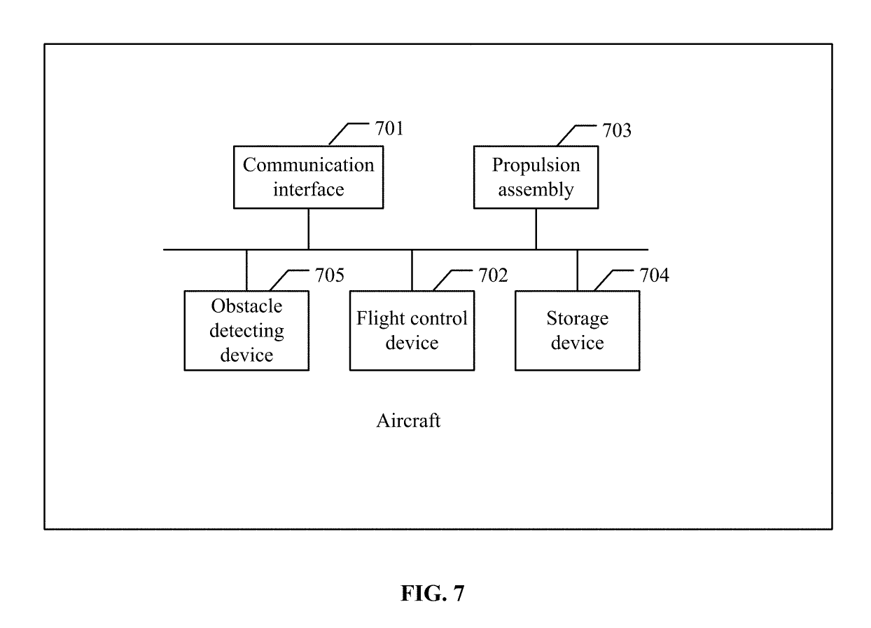

FIG. 7 is a schematic diagram showing the structure of an aircraft. In some embodiments, FIG. 7 is a schematically diagram of internal structural devices, modules, units, components, or elements that are configured for control the flight of the aircraft. In some embodiments, the aircraft may include power sources, landing gears, various indicators (e.g., indicating lamps), etc. As shown in FIG. 7, the aircraft may include a communication interface 701, a flight control device 702, one or more propulsion assemblies 703, and a storage device 704. Each propulsion assembly 703 may include a motor, a propeller, an electrical speed control, etc. The propeller may be fixedly mounted to a rotating axis of the motor. The electrical speed control may be controlled by the flight control device 702 to control the rotation direction and the speed of the motor, thereby causing the propeller to rotate, which in turn controls the flight direction and the speed of flight of the aircraft.

In some embodiments, the storage device 704 may include a volatile memory, such as a random-access memory (“RAM”). In some embodiments, the storage device 704 may include a non-volatile memory, such as a flash memory.

In some embodiments, the flight control device 702 may include a hardware chip. The hardware chip may an application-specific integrated circuit (“ASIC”), a programmable logic device (“PLD”), or a combination thereof. The PLD may be a complex programmable logic device (“CPLD”), a field-programmable gate array (“FPGA”), a generic array logic (“GAL”), or any combination thereof.

In some embodiments, the storage device 704 may be configured to store program codes or instructions. The flight control device 702 may retrieve and execute the program codes or instructions to perform the methods for controlling the flight of the aircraft, including the methods shown in FIGS. 4 and 5.

In some embodiments, the communication interface 701 may communicate with a ground terminal, other aircrafts, or a smart terminal, to transmit or receive control signals and/or data of images captured by an imaging device. In some embodiments, the one or more propulsion assemblies 703 may be configured to provide a propulsion force for the flight of the aircraft. In some embodiments, the flight control device 702 may retrieve program codes or instructions stored in the storage device 704 and execute the program codes or instructions to perform at least one of the following processes: obtaining a location of a target area in an image captured by an imaging device mounted on the aircraft; determining, based on the location of the target area, a relative direction of a target object corresponding to the target area relative to the aircraft; determining a first direction based on the relative direction, the first direction being a direction approaching the target object; based on a determination that the aircraft is in a first flight mode, determining a second direction based on the first direction; transmitting a flight control instruction to the propulsion assembly 703 based on the second direction, wherein the flight control instruction is configured for controlling the flight of the aircraft, and the second direction is opposite the first direction.

In some embodiments, the flight control device 702 may be configured to determine that the aircraft is in the second flight mode, and based on the determination that the aircraft is in the second flight mode, the flight control device 702 may control the aircraft to fly in the first direction.

In some embodiments, the flight control device 702 may be configured to, during the flight of the aircraft, release a control of a yaw direction of the aircraft based on a determination that the aircraft is in a third flight mode. The flight control device 702 may control, based on a received flight control instruction comprising a yaw angle, the aircraft to rotate in the yaw direction based on the yaw angle.

In some embodiments, the flight control device 702 may be configured to, during the flight of the aircraft in a current flight mode, control the aircraft to exit the current flight mode based on a detection that the aircraft satisfies a predetermined exit condition. The current flight mode may be the first flight mode, a second flight mode, or the third flight mode.

In some embodiments, the detection of the aircraft satisfying the predetermined exit condition includes at least one of: receipt of a control instruction instructing the aircraft to exit the current flight mode, detection of a current location of the aircraft satisfying a predetermined flight-restricting condition, detection of the aircraft satisfying a predetermined obstacle avoidance condition, or detection of a flight distance travelled by the aircraft operating in the current flight mode being greater than or equal to one or more predetermined distance values.

In some embodiments, the aircraft may include an obstacle detecting device 705 configured to detect obstacle information in the flight direction. In some embodiments, the flight control device 702 may be configured to transmit, based on the second direction and obstacle information detected in the second direction, a control instruction to control the aircraft to fly along the second direction to circumvent (or avoid) an obstacle indicated by the obstacle information.

In some embodiments, the flight control device 702 may be configured to transmit an attitude adjusting instruction to the aircraft for controlling an adjustment to an attitude of the aircraft, the adjustment to the attitude of the aircraft enabling the obstacle detecting device 705 to detect the obstacle in the second direction and enabling the imaging device to capture an image of the target object during flight of the aircraft in the second direction.

In some embodiments, the flight control device 702 may be configured to transmit an attitude adjusting instruction to the aircraft for controlling an adjustment to an attitude of the aircraft, the adjustment to the attitude of the aircraft enabling the obstacle detecting device 705 to detect the obstacle in the second direction. The flight control device 702 may transmit a rotation instruction to the gimbal for controlling a rotation of the gimbal, the rotation of the gimbal enabling the imaging device to capture an image of the target object during flight of the aircraft in the second direction.

The detailed implementation of the flight control device 702 in the aircraft may refer to the descriptions of the corresponding functions and methods.

In various embodiments of the present disclosure, the flight direction of the aircraft may be determined based on the location of the target area in the image. A user may select a target object for imaging from an image area. The operation is simple. The efficiency of flight control for capturing images of the target object is enhanced. User demands for automation and intelligence of the flight control of aircrafts and image capturing can be satisfied.

A person having ordinary skill in the art can appreciate that part or all of the steps of the disclosed methods may be implemented using computer software programs instructing or controlling related hardware. The computer software programs may be stored as computer-readable codes or instructions in a computer-readable medium, such as a non-transitory computer-readable medium. When the computer software programs are executed, the programs may carry out the steps of the disclosed methods. The computer-readable medium may include at least one of a magnetic disk, an optical disk, a read-only memory (“ROM”), or a random access memory (“RAM”), etc.

A person having ordinary skill in the art can appreciate that the above embodiments are only examples of the present disclosure, and do not limit the scope of the present disclosure. Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. A method for controlling flight of an aircraft, comprising:
obtaining a location of a target area in an image captured by an imaging device mounted on the aircraft;
determining, based on the location of the target area, a relative direction of a target object corresponding to the target area relative to the aircraft;
determining a first direction based on the relative direction, the first direction being a direction approaching the target object;
based on a determination that the aircraft is in a moving-away flight mode, determining a second direction based on the first direction, the second direction being opposite the first direction; and
controlling the flight of the aircraft based on the second direction.

2. The method of claim 1, further comprising:
during the flight of the aircraft,
releasing a control of a yaw direction of the aircraft based on a determination that the aircraft is in a headless flight mode; and
controlling, based on a received flight control instruction comprising a yaw angle, the aircraft to rotate in the yaw direction based on the yaw angle.

3. The method of claim 2, further comprising:
during the flight of the aircraft in a current flight mode, controlling the aircraft to exit the current flight mode based on a detection that the aircraft satisfies a predetermined exit condition,
wherein the current flight mode is the moving-away flight mode, a moving-closer flight mode, or the headless flight mode.

4. The method of claim 3, wherein the detection of the aircraft satisfying the predetermined exit condition comprises at least one of:
receipt of a control instruction instructing the aircraft to exit the current flight mode,
detection of a current location of the aircraft satisfying a predetermined flight-restricting condition,
detection of the aircraft satisfying a predetermined obstacle avoidance condition, or
detection of a flight distance travelled by the aircraft operating in the current flight mode being greater than or equal to one or more predetermined distance values.

5. The method of claim 1, wherein controlling the flight of the aircraft based on the second direction comprises:
transmitting, based on the second direction and obstacle information detected in the second direction, a control instruction to control the aircraft to fly along the second direction to circumvent an obstacle indicated by the obstacle information.

6. The method of claim 5, further comprising detecting, by an obstacle detecting device of the aircraft, the obstacle information in the second direction,
wherein detecting the obstacle information comprises:
transmitting an attitude adjusting instruction to the aircraft for controlling an adjustment to an attitude of the aircraft, the adjustment to the attitude of the aircraft enabling the obstacle detecting device to detect the obstacle in the second direction and enabling the imaging device to capture an image of the target object during flight of the aircraft in the second direction.

7. The method of claim 5, wherein the aircraft comprises an obstacle detecting device, and the imaging device is rotatably mounted to the aircraft through a gimbal, wherein the method further comprises detecting, by the obstacle detecting device, the obstacle information in the second direction, and
wherein detecting the obstacle information comprises:
transmitting an attitude adjusting instruction to the aircraft for controlling an adjustment to an attitude of the aircraft, the adjustment to the attitude of the aircraft enabling the obstacle detecting device to detect the obstacle in the second direction; and
transmitting a rotation instruction to the gimbal for controlling a rotation of the gimbal, the rotation of the gimbal enabling the imaging device to capture an image of the target object during flight of the aircraft in the second direction.

8. A flight control device for controlling flight of an aircraft, comprising:
a memory configured to store computer-executable instructions;
an acquisition processor configured to execute the computer-executable instructions to obtain a location of a target area in an image captured by an imaging device mounted on the aircraft;
a determination processor configured to execute the computer-executable instructions to:
determine, based on the location of the target area, a relative direction of a target object corresponding to the target area relative to the aircraft; and
determine a first direction based on the relative direction, the first direction being a direction approaching the target object; and
a control processor configured to execute the computer-executable instructions to:
determine that the aircraft is in a moving-away flight mode, and based on the determination that the aircraft is in the moving-away flight mode, determine a second direction based on the first direction, the second direction being opposite the first direction; and
control the flight of the aircraft based on the second direction.

9. The flight control device of claim 8, wherein the control processor is further configured to execute the computer-executable instructions to:
during the flight of the aircraft,
release a control of a yaw direction of the aircraft based on a determination that the aircraft is in a headless flight mode; and
control, based on a received flight control instruction comprising a yaw angle, the aircraft to rotate in the yaw direction based on the yaw angle.

10. The flight control device of claim 8, wherein the control processor is further configured to execute the computer-executable instructions to:
during the flight of the aircraft in a current flight mode, control the aircraft to exit the current flight mode based on a detection that the aircraft satisfies a predetermined exit condition,
wherein the current flight mode is the moving-away flight mode, a moving-closer flight mode, or the headless flight mode.

11. The flight control device of claim 10, wherein the detection of the aircraft satisfying the predetermined exit condition comprises at least one of:
receipt of a control instruction for instructing the aircraft to exit the current flight mode,
detection of a current location of the aircraft satisfying a predetermined flight-restricting condition,
detection of the aircraft satisfying a predetermined obstacle avoidance condition, or
detection of a flight distance travelled by the aircraft operating in the current flight mode being greater than or equal to one or more predetermined distance values.

12. The flight control device of claim 11, wherein the control processor is further configured to execute the computer-executable instructions to transmit, based on the second direction and obstacle information detected in the second direction, a control instruction to control the aircraft to fly along the second direction to circumvent an obstacle indicated by the obstacle information.

13. The flight control device of claim 12,
wherein the aircraft comprises an obstacle detecting device configured to detect an obstacle, and
wherein the control processor is further configured to execute the computer-executable instructions to transmit an attitude adjusting instruction to the aircraft for controlling an adjustment to an attitude of the aircraft, the adjustment to the attitude of the aircraft enabling the obstacle detecting device to detect the obstacle in the second direction and enabling the imaging device to capture an image of the target object during flight of the aircraft in the second direction.

14. The flight control device of claim 12,
wherein the aircraft comprises an obstacle detecting device configured to detect an obstacle,
wherein the imaging device is rotatably mounted to the aircraft through a gimbal, and
wherein the control processor is further configured to execute the computer-executable instructions to:
transmit an attitude adjusting instruction to the aircraft for controlling an adjustment to an attitude of the aircraft, the adjustment to the attitude of the aircraft enabling the obstacle detecting device to detect the obstacle in the second direction; and
transmit a rotation instruction to the gimbal for controlling a rotation of the gimbal, the rotation of the gimbal enabling the imaging device to capture an image of the target object during flight of the aircraft in the second direction.

15. An aircraft, comprising:
a propulsion assembly configured to provide a propulsion force for flight of the aircraft; and
a flight control device configured to:
obtain a location of a target area in an image captured by an imaging device mounted on the aircraft;
determine, based on the location of the target area, a relative direction of a target object corresponding to the target area relative to the aircraft;
determine a first direction of the aircraft based on the relative direction, the first direction being a direction approaching the target object;
based on a determination that the aircraft is in a moving-away flight mode, determine a second direction based on the first direction, the second direction being opposite the first direction; and
transmit a flight control instruction to the propulsion assembly based on the second direction,
wherein the flight control instruction is configured for controlling flight of the aircraft.

16. The aircraft of claim 15, wherein the flight control device is further configured to:
during the flight of the aircraft,
release a control of a yaw direction of the aircraft based on a determination that the aircraft is in a headless flight mode; and
control, based on a received flight control instruction comprising a yaw angle, the aircraft to rotate in the yaw direction based on the yaw angle.

17. The aircraft of claim 16, wherein the flight control device is further configured to:
during the flight of the aircraft in a current flight mode, control the aircraft to exit the current flight mode based on a detection that the aircraft satisfies a predetermined exit condition,
wherein the currently flight mode is the moving-away flight mode, a moving-closer flight mode, or the headless flight mode.

18. The aircraft of claim 17, wherein the detection of the aircraft satisfying the predetermined exit condition comprises at least one of:
receipt of a control instruction for instructing the aircraft to exit the current flight mode,
detection of a location of the aircraft satisfying a predetermined flight-restricting condition,
detection of aircraft satisfying a predetermined obstacle avoidance condition, or
detection of a flight distance travelled by the aircraft operating in the current flight mode being greater than or equal to one or more predetermined distance values.

19. The aircraft of claim 15, wherein the flight control device is further configured to transmit, based on the second direction and obstacle information detected in the second direction, a control instruction to control the aircraft to fly along the second direction to circumvent an obstacle indicated by the obstacle information.

20. The aircraft of claim 19, wherein the flight control device is further configured to:
transmit an attitude adjusting instruction to the aircraft for controlling an adjustment to an attitude of the aircraft, the adjustment to the attitude of the aircraft enabling the obstacle detecting device to detect the obstacle in the second direction; and
transmit a rotation instruction to the gimbal for controlling a rotation of the gimbal, the rotation of the gimbal enabling the imaging device to capture an image of the target object during flight of the aircraft in the second direction.
